(19) United States
(12) Patent Application Publication
(10) Pub. No.: US 2024/0166381 A1
(43) Pub. Date: May 23, 2024

(54) UNMANNED AERIAL VEHICLE AND WING THEREOF

(71) Applicant: AUTEL ROBOTICS CO., LTD., Shenzhen (CN)

(72) Inventors: Zhuanpeng CHENG, Shenzhen (CN); Feifei YAO, Shenzhen (CN); Ao HE, Shenzhen (CN)

(21) Appl. No.: 18/512,399

(22) Filed: Nov. 17, 2023

(30) Foreign Application Priority Data
Nov. 18, 2022 (CN) 202211463925.0

(51) Int. Cl. B64U 10/25; B64U 20/50; B64U 30/10

(52) U.S. Cl. CPC B64U 10/25; B64U 20/50; B64U 30/10

(57) ABSTRACT

The present disclosure discloses an unmanned aerial vehicle and a wing thereof. The wing includes an intermediate wing assembly, configured to connect to a fuselage of an unmanned aerial vehicle; an outer wing, arranged corresponding to the intermediate wing assembly and located on a side of the intermediate wing assembly away from the fuselage when the outer wing is in an unfolded state; and a folding apparatus, including a driver and a first rotating shaft, the driver being connected to the intermediate wing assembly and the first rotating shaft including a first rotating portion and a first fixed portion that are rotatably connected, the first fixed portion being connected to the intermediate wing assembly and the first rotating portion being connected to the outer wing, the first rotating portion being further connected to an output end of the driver, to rotatably connect the outer wing and the intermediate wing assembly.

### CROSS-REFERENCE TO RELATED APPLICATIONS

This application claims priority of Chinese Patent Application No. 20221146392.0, filed on Nov. 18, 2022, entitled as “Unmanned aerial vehicle and wing thereof”, the contents of which are incorporated herein by reference.

### BACKGROUND

With the development of science and technologies, applications of unmanned aerial vehicles in the civilian field are increasing. As performance requirements for unmanned aerial vehicles increase, particularly, volumes of fixed-wing unmanned aerial vehicles or fixed-wing and rotary-wing combined unmanned aerial vehicles are also increasingly large.

Wings are perpendicular to a fuselage. The wings and the fuselage are main space-consuming parts because they all have large lengths. Particularly, with regard to the wing portion, to ensure flight performance of the unmanned aerial vehicle, the length of the wing is usually greater than the length of the fuselage. Therefore, the existing wing structure causes the unmanned aerial vehicle to consume a large space, which is not conducive to transportation and storage.

### SUMMARY

The present disclosure relates to the field of unmanned aerial vehicle devices and in particular, to an unmanned aerial vehicle and a wing thereof.

The present disclosure mainly provides an unmanned aerial vehicle and a wing thereof, to resolve a problem that an existing wing structure causes an unmanned aerial vehicle to consume a large space, which is conducive to transportation and storage.

The first aspect of the present disclosure provides a wing, comprising an intermediate wing assembly, configured to connect to a fuselage of the unmanned aerial vehicle; an outer wing, arranged corresponding to the intermediate wing assembly and located on a side of the intermediate wing assembly away from the fuselage when the outer wing is in an unfolded state; and a folding apparatus, including a driver and a first rotating shaft, the driver being connected to the intermediate wing assembly and the first rotating shaft including a first rotating portion and a first fixed portion that are rotatably connected, the first fixed portion being connected to the intermediate wing assembly and the first rotating portion being connected to the outer wing, the first rotating portion being further connected to an output end of the driver, to enable the driver to drive the first rotating portion to rotate, the first rotating portion driving the outer wing to rotate relative to the intermediate wing assembly.

The second aspect of the present disclosure provides an unmanned aerial vehicle. The unmanned aerial vehicle includes a fuselage and a wing connected to the fuselage. The wing is the wing according to any of the foregoing aspects.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show merely some embodiments of the present disclosure. A person of ordinary skill in the art may still derive other drawings from the accompanying drawings without creative efforts.

FIG. 1 is a schematic structural diagram of a wing of an unmanned aerial vehicle according to the present disclosure during folding:

FIG. 2 is a schematic structural diagram of a folding apparatus of the wing in FIG. 1; and

FIG. 3 is a schematic structural diagram of an implementation of an unmanned aerial vehicle according to the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely some rather than all of the embodiments of the present disclosure. All other embodiments obtained by a person of ordinary skill in the art based on embodiments of the present disclosure without creative efforts shall fall within the protection scope of the present disclosure.

The terms used in embodiments of the present disclosure are merely for the purpose of illustrating specific embodiments and are not intended to limit the present disclosure. The terms “a”, “the” and “said” of singular forms used in the embodiments and the appended claims of the present disclosure are also intended to include plural forms, unless other meanings are clearly indicated in the context. “A plurality of” generally means including at least two, but does not exclude the case of including at least one.

The term “and/or” used in this specification describes only an association relationship for describing associated objects and represents that three relationships may exist. For example, A and/or B may represent the following three cases: Only A exists, both A and B exist and only B exists. In addition, the character “/” in this specification generally indicates an “or” relationship between the associated objects.

It should be understood that terms “include”, “comprise” or any other variants are intended to encompass non-exclusive inclusion, such that a process, a method, an article or a device including a series of elements not only includes those elements, but also includes other elements not listed explicitly or includes intrinsic elements for the process, the method, the article or the device. Unless otherwise specified, an element limited by “include . . . ” does not exclude other same elements existing in the process, the method, the article or the device that includes the element.

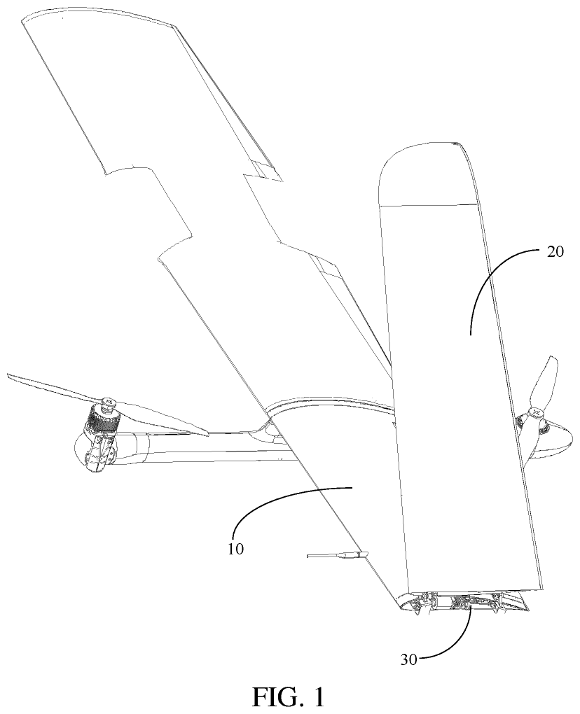

Referring to FIG. 1, FIG. 1 is a schematic structural diagram of a wing of an unmanned aerial vehicle according to the present disclosure during folding. In this embodiment, a wing includes an intermediate wing assembly 10, an outer wing 20 and a folding apparatus 30.

The intermediate wing assembly 10 is configured to connect to a fuselage of an unmanned aerial vehicle. The outer wing 20 is arranged corresponding to an end of the intermediate wing assembly 10. The intermediate wing assembly 10 may include a plurality of components, for example, a central wing and two intermediate wings. The two intermediate wings are located on two opposite sides of the central wing respectively. One end of the intermediate wing is connected to the central wing and an other end of the intermediate wing is connected to the outer wing 20. Moreover, the central wing is configured to connect to the fuselage. There may be only one central wing or the central wing is formed by splicing or connecting two parts. Alternatively, one or more wing bodies may be added between the central wing and the intermediate wing, to form a multi-section wing mechanism. To sum up, a structure of the intermediate wing assembly 10 may be adjusted according to requirements. The central wing may be detachably connected to the fuselage by an elastic fixing pin or be detachably connected to the fuselage in a manner such as snap-fitting or be fixedly connected to the fuselage through welding or one-piece molding. The outer wing 20 is located on a side of the intermediate wing assembly 10 away from the fuselage when the outer wing 20 is in an unfolded state. That is, the outer wings 20 in the unfolded state are located on two opposite sides of the intermediate wing assembly 10 and arranged in a posture of being away from each other, which is a state during flight. The outer wing 20 in a folded state is located above the intermediate wing assembly 10, which is a state during retraction. In a preferable implementation, the outer wing 20 in a folded state is parallel to the intermediate wing assembly 10 or is close to an upper surface of the intermediate wing assembly 10. To maximize space saving, two outer wings 20 may be respectively arranged on two opposite sides of the intermediate wing assembly 10. The intermediate wing assembly 10 is arranged across the fuselage.

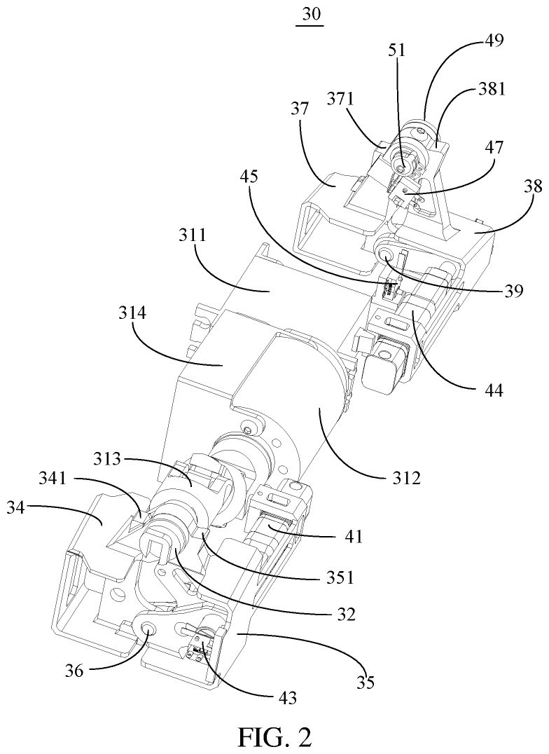

Further referring to FIG. 2, FIG. 2 is a schematic structural diagram of a folding apparatus of the wing in FIG. 1. The folding apparatus 30 includes a driver and a first rotating shaft 32. The driver is connected to the intermediate wing assembly 10. Specifically, an accommodating space is formed at one end of the intermediate wing assembly 10 close to the outer wing 20. An opening of the accommodating space faces toward the outer wing 20. At least a part of the driver is arranged in the accommodating space of the intermediate wing assembly 10. The first rotating shaft 32 includes a first rotating portion and a first fixed portion that are rotatably connected. The first fixed portion is connected to the intermediate wing assembly 10. The first rotating portion is connected to the outer wing 20. The first rotating portion is further connected to an output end of the driver, to enable the driver to drive the first rotating portion to rotate. The first rotating portion drive the outer wing 20 to rotate relative to the intermediate wing assembly 10.

Specifically, the driver is a rotation output mechanism 31. An output end of the rotation output mechanism 31 is connected to the first rotating portion, to drive the first rotating portion to rotate relative to the first fixed portion. The output end of the rotation output mechanism 31 outputs a rotational force, to directly drive the first rotating shaft 32 without requiring a component, such as a connecting rod, to conduct the force, so that folding of the wing can be implemented through a simple structure. The rotation output mechanism 31 includes a rotation output member 311, a reducer 312 and a universal joint 313. The rotation output member 311 is connected to the intermediate wing assembly 10 by a holder 314. An output end of the rotation output member 311 is connected to an input end of the reducer 312. An output end of the reducer 312 is connected to the first rotating portion. The reducer 312 may also be connected to the holder 314 for fixation. Alternatively, the reducer 312 may also be connected to the intermediate wing assembly 10 by another auxiliary fixing component. The rotation output member 311 is a steering gear or a motor, most preferably, a steering gear with high precision, so that an accurate rotation angle can be obtained. The output end of the reducer 312 is connected to the first rotating portion by the universal joint 313, to form a specific buffer between the output end of the reducer 312 and the first rotating portion, thereby reducing wear and prolonging the service life.

To make the connection between the rotating shaft 32 and the intermediate wing assembly 10 and the connection between the rotating shaft 32 and the outer wing 20 smoother, the folding apparatus 30 further includes a first connecting member 34 and a second connecting member 35. The intermediate wing assembly 10 is connected to the first fixed portion of the first rotating shaft 32 by the first connecting member 34. The outer wing 20 is connected to the first rotating portion by the second connecting member 35. A first fixing hole is formed at an end of the first connecting member 34 away from the first fixed portion. A second fixing hole is formed at an end of the second connecting member 35 away from the first rotating portion. The first fixing hole and the second fixing hole are located on a same straight line when the outer wing 20 is in the unfolded state. The folding apparatus 30 further includes a first fixing member 36 and a first linear driving apparatus 41. The first linear driving apparatus 41 is connected to the second connecting member 35. In another implementation, the first linear driving apparatus 41 may alternatively be connected to the first connecting member 34. However, to allow the first linear driving apparatus 41 to have a space that is large enough, the first linear driving apparatus 41 is connected to the second connecting member 35 in this implementation to prevent the first linear driving apparatus 41 from conflicting with a component such as the reducer 312. An output end of the first linear driving apparatus 41 is connected to the first fixing member 36, to drive the first fixing member 36 to pass through or escape from the first fixing hole and the second fixing hole. In another implementation, the first linear driving apparatus 41 may be further connected to one of the first connecting member 34, the intermediate wing assembly 10, the outer wing 20 or the driver. The folding apparatus 30 further includes a first touch switch (not shown) and a second touch switch 43. The first touch switch is connected to the first connecting member 34 or the second connecting member 35. The first touch switch further corresponds to the first fixing hole and the second fixing hole when the outer wing 20 is in the unfolded state. The first fixing member 36 touches the first touch switch after escaping from the first fixing hole and the second fixing hole. The second touch switch 43 is connected to the second connecting member 35. The second touch switch 43 is arranged corresponding to the output end of the first linear driving apparatus 41. When the outer wing 20 is in the unfolded state, the output end of the first linear driving apparatus 41 touches the second touch switch 43 after the first fixing member 36 passes through the first fixing hole and the second fixing hole. In another implementation, the second touch switch 43 may be further connected to the first connecting member 34 instead of the second connecting member 35. The wing further includes a main control apparatus. The main control apparatus is communicatively connected to the first touch switch, the second touch switch 43 and the first linear driving apparatus 41. The main control apparatus controls a working state of the first linear driving apparatus 41 and controls, when the first touch switch and the second touch switch 43 are triggered, the first linear driving apparatus 41 to stop working. Under the control of the main control apparatus, the first linear driving apparatus 41 only works when the outer wing 20 is in the unfolded state. When the unmanned aerial vehicle needs to fly or during take-off of the unmanned aerial vehicle, the outer wing 20 needs to be unfolded from the folded state until it reaches the unfolded state. When the unfolded state is reached, the outer wing 20 needs to be fixed to the intermediate wing assembly 10. That is, the first connecting member 34 needs to be fixed to the second connecting member 35. In this case, the main control apparatus controls the first linear driving apparatus 41 to start working, to push the first fixing member 36 to pass through the first fixing hole and the second fixing hole until the first fixing member 36 abuts against the second touch switch 43. The second touch switch 43 feeds back a switch signal to the main control apparatus. The main control apparatus controls the first linear driving apparatus 41 to stop working. When the unmanned aerial vehicle needs to retract or during landing of the unmanned aerial vehicle, the outer wing 20 needs to be folded from the unfolded state until it reaches the folded state. In this case, fixation between the first connecting member 34 and the second connecting member 35 needs to be released. The main control apparatus controls the first linear driving apparatus 41 to work reversely, to drive the first fixing member 36 to escape from the first fixing hole and the second fixing hole until the first fixing member 36 abuts against the first touch switch. The first touch switch feeds back a switch signal to the main control apparatus. The main control apparatus controls the first linear driving apparatus 41 to stop working. The second connecting member 35 may rotate relative to the first connecting member 34.

To further enhance the connection stability between the first connecting member 34 and the intermediate wing assembly 10 and between the second connecting member 35 and the outer wing 20, the folding apparatus 30 further includes a third connecting member 37, a fourth connecting member 38, a second rotating shaft 49, a second linear driving apparatus 44, a second fixing member 39, a third touch switch 45 and a fourth touch switch (not shown). The second rotating shaft 49 includes a second rotating portion and a second fixed portion that are rotatably connected. The third connecting member 37 connects to one of the second rotating portion and the second fixed portion and further connects to the intermediate wing assembly 10. The fourth connecting member 38 connects to the other of the second rotating portion and the second fixed portion and further connects to the outer wing 20. The third connecting member 37 is provided with a third fixing hole. The fourth connecting member 38 is provided with a fourth fixing hole. The third fixing hole and the fourth fixing hole are located on a same straight line when the outer wing 20 is in the unfolded state. The second linear driving apparatus 44 is connected to the fourth connecting member 38. In another implementation, the second linear driving apparatus 44 may be further connected to one of the third connecting member 37, the intermediate wing assembly 10, the outer wing 20 or the driver. An output end of the second linear driving apparatus 44 is connected to the second fixing member 39, to drive the second fixing member 39 to pass through or escape from the third fixing hole and the fourth fixing hole. The third touch switch 45 is connected to the fourth connecting member 38. The fourth touch switch is connected to the third connecting member 37 or the fourth connecting member 38. In another implementation, the third touch switch 45 may alternatively be connected to the third connecting member 37. The third touch switch 45 further corresponds to the third fixing hole and the fourth fixing hole when the outer wing 20 is in the unfolded state. The second fixing member 39 touches the third touch switch 45 after escaping from the third fixing hole and the fourth fixing hole. The fourth touch switch is arranged corresponding to the output end of the second linear driving apparatus 44. When the outer wing 20 is in the unfolded state, the output end of the second linear driving apparatus 44 touches the fourth touch switch after the second fixing member 39 passes through the third fixing hole and the fourth fixing hole. The second linear driving apparatus 44, the third touch switch 45 and the second linear driving apparatus 44 are communicatively connected to the main control apparatus. The working mode of the second linear driving apparatus 44, the third touch switch 45 and the fourth touch switch is similar to the working mode of the first linear driving apparatus 41, the first touch switch and the second touch switch 43. Details are not described herein again. Arrangement of the third connecting member 37 and the fourth connecting member 38 can increase the connection areas between the intermediate wing assembly 10 and the folding apparatus 30 and between the outer wing 20 and the folding apparatus 30, to reduce forces on the connection surfaces and further enhance the connection strength. The first connecting member 34 and the third connecting member 37 may connect to the intermediate wing assembly 10 by pasting, screwing or riveting. The second connecting member 35 and the fourth connecting member 38 may connect to the outer wing 20 by pasting, screwing or riveting.

To prevent the intermediate wing assembly 10 and the outer wing 20 from being folded to an excessive degree during folding and causing the intermediate wing assembly 10 and the outer wing 20 to squeeze each other, resulting in damage, in this implementation, a first rotating contact surface 341 is further formed on the first connecting member 34 and a second rotating contact surface 351 is further formed on the second connecting member 35. The first rotating contact surface 341 is arranged corresponding to the second rotating contact surface 351. The first rotating contact surface 341 abuts against the second rotating contact surface 351 after the second connecting member 35 rotates by a preset angle, during which the outer wing 20 is in the folded state. A third rotating contact surface 371 is formed on the third connecting member 37. A fourth rotating contact surface 381 is formed on the fourth connecting member 38. The third rotating contact surface 371 abuts against the fourth rotating contact surface 381 after the fourth connecting member 38 is driven by the outer wing 20 to rotate by a preset angle, during which the outer wing 20 is in the folded state. When the outer wing 20 is folded to a specified position, the first rotating contact surface 341 is in contact with the second rotating contact surface 351 and the third rotating contact surface 371 is in contact with the fourth rotating contact surface 381, to support each other and prevent the outer wing 20 from continuing rotating relative to the intermediate wing assembly 10, thereby protecting the outer wing 20 and the intermediate wing assembly 10.

In this implementation, a toggle block 51 is arranged on the second rotating portion and a fifth touch switch 47 is arranged on the third connecting member 37. When the third rotating contact surface 371 abuts against the fourth rotating contact surface 381, the toggle block 51 touches the fifth touch switch 47. In another implementation, alternatively, the toggle block 51 may be arranged on the first rotating portion and the fifth touch switch 47 may be arranged on the first connecting member 34. When the first rotating contact surface 341 abuts against the second rotating contact surface 351, the toggle block 51 touches the fifth touch switch 47. The toggle block 51 includes a protruding portion. Only the protruding portion needs to touch the second touch switch 43. Moreover, in another implementation, the toggle block 51 in various forms may be used and may be a bar-shaped block or the like provided that the toggle block 51 can rotate and touch the second touch switch 43. The fifth touch switch 47 is communicatively connected to the main control apparatus. The main control apparatus is further communicatively connected to the rotation output member 311 and controls a working state of the rotation output member 311. The main control apparatus controls, when the fifth touch switch 47 is touched, the rotation output member 311 to stop working.

A sixth touch switch is arranged on the fourth connecting member 38 and the sixth touch switch is arranged corresponding to the third connecting member 37. The third connecting member 37 abuts against the sixth touch switch when the outer wing 20 is in the unfolded state. In another implementation, the sixth touch switch is arranged on the first connecting member 34 and the sixth touch switch is arranged corresponding to second connecting member 35. When the outer wing 20 is in the unfolded state, the second connecting member 35 touches the sixth touch switch. Alternatively, the sixth touch switch is arranged on the second connecting member 35 and the sixth touch switch is arranged corresponding to the first connecting member 34. The first connecting member 34 touches the sixth touch switch when the outer wing 20 is in the unfolded state. Alternatively, the sixth touch switch is arranged on the third connecting member 37 and the sixth touch switch is arranged corresponding to the fourth connecting member 38. The fourth connecting member 38 abuts against the sixth touch switch when the outer wing 20 is in the unfolded state. The main control apparatus is communicatively connected to the sixth touch switch. The main control apparatus controls, when the sixth touch switch is triggered, the rotation output member 311 to stop working.

When the unmanned aerial vehicle needs to be retracted or the unmanned aerial vehicle is about to land, the main control apparatus first controls the first linear driving apparatus 41 to drive the first fixing member 36 to escape from the first fixing hole and the second fixing hole and unlock the first connecting member 34 and the second connecting member 35 and simultaneously controls the second linear driving apparatus 44 to drive the second fixing member 39 to escape from the third fixing hole and the fourth fixing hole and unlock the third connecting member 37 and the fourth connecting member 38. After being triggered, the first touch switch and the third touch switch 45 may send switch signals to the main control apparatus. The main control apparatus controls the first linear driving apparatus 41 and the second linear driving apparatus 44 to stop working and simultaneously controls the rotation output member 311 to start working. The rotation output member 311 drives the first rotating portion of the first rotating shaft 32 through the reducer 312 and the universal joint 313 to rotate. The first rotating portion further drives the second connecting member 35 to rotate. The second connecting member 35 further drives the outer wing 20 to rotate. In addition, the outer wing 20 drives the fourth connecting member 38 to rotate. The fourth connecting member 38 further drives the second rotating portion if the second rotating shaft 49 to rotate, to drive the toggle block 51 to move. In this case, the outer wing 20 moves from the unfolded state to the folded state. When the outer wing 20 rotates to the specified position, the toggle block 51 touches the fifth touch switch 47. The fifth touch switch 47 feeds back a switch signal to the main control apparatus. The main control apparatus controls the rotation output member 311 to stop rotating. In this case, the first rotating contact surface 341 is in contact with or is about to come into contact with the second rotating contact surface 351 and the third rotating contact surface 371 is in contact with or is about to come into contact with the fourth rotating contact surface 381. The outer wing 20 is in the folded state and is located above the intermediate wing assembly 10. When the unmanned aerial vehicle needs to fly or take off, the main control apparatus controls the rotation output member 311 to start working. The rotation output member 311 drives the first rotating portion of the first rotating shaft 32 through the reducer 312 and the universal joint 313 to rotate. The first rotating portion further drives the second connecting member 35 to rotate. The second connecting member 35 further drives the outer wing 20 to rotate. In addition, the outer wing 20 drives the fourth connecting member 38 to rotate. The fourth connecting member 38 further drives the second rotating portion if the second rotating shaft 49 to rotate, to drive the toggle block 51 to move. In this case, the outer wing 20 moves from the folded state to the unfolded state. When the outer wing 20 rotates to the specified position, the sixth touch switch is touched, generates a switch signal and sends the switch signal to the main control apparatus. The main control apparatus first controls the rotation output member 311 to stop working, simultaneously controls the first linear driving apparatus 41 to drive the first fixing member 36 to pass through the first fixing hole and the second fixing hole and lock the first connecting member 34 and the second connecting member 35 and simultaneously controls the second linear driving apparatus 44 to drive the second fixing member 39 to pass through the third fixing hole and the fourth fixing hole and lock the third connecting member 37 and the fourth connecting member 38. When the first fixing member 36 and the second fixing member 39 arrive at predetermined positions, the second touch switch 43 and the fourth touch switch are touched and send switch signals to the main control apparatus. After receiving the switch signals, the main control apparatus controls the first linear driving apparatus 41 and the second linear driving apparatus 44 to stop working. In this case, the outer wing 20 completes moving and is in the unfolded state.

In the foregoing implementation, the first fixing member 36 and the second fixing member 39 are, for example, stripes such as pin shafts and may be cylinders, cylindroids, polygons or the like. The first touch switch, the second touch switch 43, the third touch switch 45, the fourth touch switch, the fifth touch switch 47 and the sixth touch switch are, for example, micro switches. The first linear driving apparatus 41 and the second linear driving apparatus 44 are, for example, linear steering gears or are pneumatic/hydraulic pistons. The first connecting member 34 includes three sidewalls connected in sequence, a reinforcing connecting portion connecting one sidewall and the first rotating portion of the first rotating shaft 32 and a supporting portion connecting two spaced sidewalls. The first rotating contact surface 341 is formed on the reinforcing connecting portion. One or two or all of the three side walls are connected to the intermediate wing assembly 10. The supporting portion is perpendicular to the sidewalls. The first fixing hole is located on the supporting portion. The structures of the second connecting member 35, the third connecting member 37 and the fourth connecting member 38 are also the same as the structure of the first connecting member. In another implementation, the structure may be replaced with another structure provided that its functions can be implemented.

In the foregoing implementation, there are many replaceable parts or replaceable positions. For example, parts corresponding to the touch switches can be changed provided that the touch switches can be triggered when the first fixing member 36 and the second fixing member 39 move to respective specified positions. The touch switches may correspond to the first fixing member 36 and the second fixing member 39 or may correspond to the output ends of the first linear driving apparatus 41 and the second linear driving apparatus 44. The fifth touch switch 47 and the sixth touch switch may be arranged on movable parts and can implement only their respective functions provided that the fifth touch switch 47 and the sixth touch switch can be triggered when the outer wing 20 rotates to the specified position.

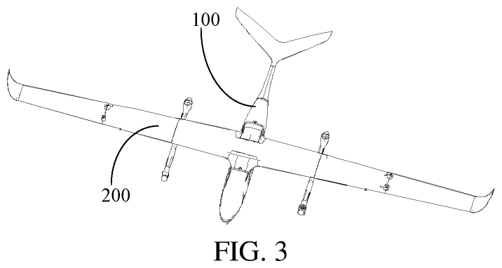

Referring to FIG. 3, FIG. 3 is a schematic structural diagram of an implementation of an unmanned aerial vehicle according to the present disclosure. The present disclosure further provides an unmanned aerial vehicle. The unmanned aerial vehicle includes a fuselage 100 and a wing 200 connected to the fuselage 100. The wing 200 may be the wing according to any of the foregoing embodiments. An intermediate wing assembly of the wing 200 is connected to the fuselage 100. A connecting mode may be a fixed connection or a detachable connection.

The unmanned aerial vehicle may be a fixed-wing unmanned aerial vehicle or may be a fixed-wing and rotary-wing combined unmanned aerial vehicle. When the unmanned aerial vehicle is a fixed-wing and rotary-wing combined unmanned aerial vehicle, a rotary wing needs to be arranged on the intermediate wing assembly.

In the foregoing manner, the wing is specified as the intermediate wing assembly and an outer wing connected by a rotating shaft of the folding apparatus, the rotating shaft being further driven by a driver in the folding apparatus to rotate, to implement folding of the wing, thereby changing a length of the wing during storage and saving space. In addition, such a folding mechanism rotates through the rotating shaft and therefore, does not need a structure such as a connecting rod, which simplifies an overall structure.

There are two outer wings, respectively arranged on two opposite sides of the intermediate wing assembly. The intermediate wing assembly is arranged across the fuselage.

The driver is a rotation output mechanism. An output end of the rotation output mechanism is connected to the first rotating portion, to drive the first rotating portion to rotate relative to the first fixed portion.

The rotation output mechanism includes a rotation output member and a reducer. The rotation output member is connected to the intermediate wing assembly by a holder. An output end of the rotation output member is connected to an input end of the reducer. An output end of the reducer is connected to the first rotating portion.

The rotation output member is a steering gear or a motor. The rotation output mechanism further includes a universal joint. An output end of the reducer being connected to the first rotating portion by the universal joint.

The folding apparatus further includes a first connecting member and a second connecting member. The intermediate wing assembly is connected to the first fixed portion of the first rotating shaft by the first connecting member. The outer wing is connected to the first rotating portion by the second connecting member.

A first fixing hole is formed at an end of the first connecting member away from the first fixed portion. A second fixing hole is formed at an end of the second connecting member away from the first rotating portion. The first fixing hole and the second fixing hole are located on a same straight line when the outer wing is in the unfolded state. The folding apparatus further includes a first fixing member and a first linear driving apparatus. The first linear driving apparatus is connected to one of the first connecting member, the second connecting member, the intermediate wing assembly, the outer wing or the driver. An output end of the first linear driving apparatus is connected to the first fixing member, to drive the first fixing member to pass through or escape from the first fixing hole and the second fixing hole.

The folding apparatus further includes a first touch switch and a second touch switch. The first touch switch is connected to the first connecting member or the second connecting member. The first touch switch further corresponds to the first fixing hole and the second fixing hole when the outer wing is in the unfolded state. The first fixing member touches the first touch switch after escaping from the first fixing hole and the second fixing hole. The second touch switch is connected to the first connecting member or the second connecting member. The second touch switch is arranged corresponding to the output end of the first linear driving apparatus. When the outer wing is in the unfolded state, the output end of the first linear driving apparatus touches the second touch switch after the first fixing member passes through the first fixing hole and the second fixing hole. The wing further includes a main control apparatus. The main control apparatus is communicatively connected to the first touch switch, the second touch switch and the first linear driving apparatus. The main control apparatus controls a working state of the first linear driving apparatus and controls, when the first touch switch and the second touch switch are triggered, the first linear driving apparatus to stop working.

The folding apparatus further includes a third connecting member, a fourth connecting member, a second rotating shaft, a second linear driving apparatus, a second fixing member, a third touch switch and a fourth touch switch. The second rotating shaft includes a second rotating portion and a second fixed portion that are rotatably connected. The third connecting member connects to one of the second rotating portion and the second fixed portion and further connects to the intermediate wing assembly. The fourth connecting member connects to the other of the second rotating portion and the second fixed portion and further connects to the outer wing. The third connecting member is provided with a third fixing hole. The fourth connecting member is provided with a fourth fixing hole. The third fixing hole and the fourth fixing hole are located on a same straight line when the outer wing is in the unfolded state. The second linear driving apparatus is connected to one of the third connecting member, the fourth connecting member, the intermediate wing assembly, the outer wing or the driver. An output end of the second linear driving apparatus is connected to the second fixing member, to drive the second fixing member to pass through or escape from the third fixing hole and the fourth fixing hole. The third touch switch is connected to the third connecting member or the fourth connecting member. The third touch switch further corresponds to the third fixing hole and the fourth fixing hole when the outer wing is in the unfolded state. The second fixing member touches the third touch switch after escaping from the third fixing hole and the fourth fixing hole. The fourth touch switch is connected to the third connecting member or the fourth connecting member. The fourth touch switch is arranged corresponding to the output end of the second linear driving apparatus. When the outer wing is in the unfolded state, the output end of the second linear driving apparatus touches the fourth touch switch after the second fixing member passes through the third fixing hole and the fourth fixing hole. The second linear driving apparatus, the third touch switch and the second linear driving apparatus are communicatively connected to the main control apparatus.

A first rotating contact surface is formed on the first connecting member. A second rotating contact surface is formed on the second connecting member. The first rotating contact surface is arranged corresponding to the second rotating contact surface. The first rotating contact surface abuts against the second rotating contact surface after the second connecting member rotates by a preset angle, during which the outer wing is in a folded state. A third rotating contact surface is formed on the third connecting member. A fourth rotating contact surface is formed on the fourth connecting member. The third rotating contact surface abuts against the fourth rotating contact surface after the fourth connecting member is driven by the outer wing to rotate by a preset angle, during which the outer wing is in the folded state.

A toggle block is arranged on the first rotating portion or the second rotating portion. A fifth touch switch is arranged on the first connecting member or the third connecting member. The toggle block touches the fifth touch switch when the first rotating contact surface abuts against the second rotating contact surface or the third rotating contact surface abuts against the fourth rotating contact surface. The fifth touch switch is communicatively connected to the main control apparatus. The main control apparatus is further communicatively connected to the rotation output member and controls a working state of the rotation output member. The main control apparatus controls, when the fifth touch switch is touched, the rotation output member to stop working.

A sixth touch switch is arranged on the first connecting member and the sixth touch switch is arranged corresponding to the second connecting member. The second connecting member touches the sixth touch switch when the outer wing is in the unfolded state. Alternatively, the sixth touch switch is arranged on the second connecting member and the sixth touch switch is arranged corresponding to the first connecting member. The first connecting member touches the sixth touch switch when the outer wing is in the unfolded state. Alternatively, the sixth touch switch is arranged on the third connecting member and the sixth touch switch is arranged corresponding to the fourth connecting member. The fourth connecting member abuts against the sixth touch switch when the outer wing is in the unfolded state. Alternatively, the sixth touch switch is arranged on the fourth connecting member and the sixth touch switch is arranged corresponding to the third connecting member. The third connecting member abuts against the sixth touch switch when the outer wing is in the unfolded state. The main control apparatus is communicatively connected to the sixth touch switch. The main control apparatus controls, when the sixth touch switch is triggered, the rotation output member to stop working.

In the foregoing solutions, the wing is specified as the intermediate wing assembly and the outer wing connected by the rotating shaft of the folding apparatus, the rotating shaft being further driven by the driver in the folding apparatus to rotate, to implement folding of the wing, thereby changing a length of the wing during storage and saving space. In addition, such a folding mechanism rotates through the rotating shaft and therefore, does not need a structure such as a connecting rod, which simplifies an overall structure.

The foregoing descriptions are merely implementations of the present disclosure. The patent scope of the present disclosure is not limited thereto. All equivalent structure or process changes made according to the content of this specification and accompanying drawings in the present disclosure or by directly or indirectly applying the present disclosure in other related technical fields shall fall within the protection scope of the present disclosure.

What is claimed is:

1. A wing of an unmanned aerial vehicle, wherein the wing comprises:
an intermediate wing assembly, configured to connect to a fuselage of the unmanned aerial vehicle;
an outer wing, arranged corresponding to the intermediate wing assembly and located on a side of the intermediate wing assembly away from the fuselage when the outer wing is in an unfolded state; and
a folding apparatus, comprising a driving unit and a coupling assembly, the driving unit being connected to the intermediate wing assembly; the coupling assembly facilitates rotational movement between the intermediate wing and the outer wing;
the driving unit is configured to transition the outer wing between the unfolded state and a folded state.

2. The wing according to claim 1, wherein the coupling assembly comprising a first rotating portion and a first fixed portion that are interconnected in a manner permitting rotation, the stationary member being connected to the outer wing, the first fixed portion being connected to the intermediate wing assembly and the first rotating portion being connected to the outer wing.
the first rotating portion being further connected to an output end of the driving unit, to enable the driving unit to drive the first rotating portion to rotate, the first rotating portion driving the outer wing to rotate relative to the intermediate wing assembly.

3. The wing according to claim 1, wherein there are two outer wings, respectively arranged on two opposite sides of the intermediate wing assembly, the intermediate wing assembly being arranged across the fuselage.

4. The wing according to claim 2, wherein the driving unit is a rotation output mechanism, an output end of the rotation output mechanism being connected to the first rotating portion, to drive the first rotating portion to rotate relative to the first fixed portion.

5. The wing according to claim 4, wherein the rotation output mechanism comprises a rotation output member and a reducer, the rotation output member being connected to the intermediate wing assembly by a holder, an output end of the rotation output member being connected to an input end of the reducer and an output end of the reducer being connected to the first rotating portion.

6. The wing according to claim 5, wherein the rotation output member is a steering gear or a motor, the rotation output mechanism further comprising a universal joint, an output end of the reducer being connected to the first rotating portion by the universal joint.

7. The wing according to claim 6, wherein the folding apparatus further comprises a first connecting member and a second connecting member, the intermediate wing assembly being connected to the first fixed portion of the first rotating shaft by the first connecting member, the outer wing being connected to the first rotating portion by the second connecting member.

8. The wing according to claim 7, wherein a first fixing hole is formed at an end of the first connecting member away from the first fixed portion and a second fixing hole is formed at an end of the second connecting member away from the first rotating portion, the first fixing hole and the second fixing hole being located on a same straight line when the outer wing is in the unfolded state; and the folding apparatus further comprises a first fixing member and a first linear driving apparatus, the first linear driving apparatus being connected to one of the first connecting member, the second connecting member, the intermediate wing assembly, the outer wing or the driving unit, an output end of the first linear driving apparatus being connected to the first fixing member, to drive the first fixing member to pass through or escape from the first fixing hole and the second fixing hole.

9. The wing according to claim 8, wherein the folding apparatus further comprises a first touch switch and a second touch switch, the first touch switch being connected to the first connecting member or the second connecting member, the first touch switch further corresponding to the first fixing hole and the second fixing hole when the outer wing is in the unfolded state, the first fixing member touching the first touch switch after escaping from the first fixing hole and the second fixing hole; the second touch switch is connected to the first connecting member or the second connecting member, the second touch switch being arranged corresponding to the output end of the first linear driving apparatus, when the outer wing is in the unfolded state, the output end of the first linear driving apparatus touching the second touch switch after the first fixing member passes through the first fixing hole and the second fixing hole; and the wing further comprises a main control apparatus, the main control apparatus being communicatively connected to the first touch switch, the second touch switch and the first linear driving apparatus, the main control apparatus controlling a working state of the first linear driving apparatus and controlling, when the first touch switch and the second touch switch are triggered, the first linear driving apparatus to stop working.

10. The wing according to claim 7, wherein the folding apparatus further comprises a third connecting member, a fourth connecting member, a second rotating shaft, a second linear driving apparatus, a second fixing member, a third touch switch and a fourth touch switch, the second rotating shaft comprising a second rotating portion and a second fixed portion that are rotatably connected, the third connecting member connecting to one of the second rotating portion and the second fixed portion and further connecting to the intermediate wing assembly, the fourth connecting member connecting to the other of the second rotating portion and the second fixed portion and further connecting to the outer wing, the third connecting member being provided with a third fixing hole and the fourth connecting member being provided with a fourth fixing hole, the third fixing hole and the fourth fixing hole being located on a same straight line when the outer wing is in the unfolded state; the second linear driving apparatus is connected to one of the third connecting member, the fourth connecting member, the intermediate wing assembly, the outer wing or the driving unit, an output end of the second linear driving apparatus being connected to the second fixing member, to drive the second fixing member to pass through or escape from the third fixing hole and the fourth fixing hole; the third touch switch is connected to the third connecting member or the fourth connecting member, the third touch switch further corresponding to the third fixing hole and the fourth fixing hole when the outer wing is in the unfolded state, the second fixing member touching the third touch switch after escaping from the third fixing hole and the fourth fixing hole; the fourth touch switch is connected to the third connecting member or the fourth connecting member, the fourth touch switch being arranged corresponding to the output end of the second linear driving apparatus, when the outer wing is in the unfolded state, the output end of the second linear driving apparatus touching the fourth touch switch after the second fixing member passes through the third fixing hole and the fourth fixing hole; and the second linear driving apparatus, the third touch switch and the second linear driving apparatus are communicatively connected to the main control apparatus.

11. The wing according to claim 8, wherein a first rotating contact surface is formed on the first connecting member and a second rotating contact surface is formed on the second connecting member, the first rotating contact surface being arranged corresponding to the second rotating contact surface, the first rotating contact surface abutting against the second rotating contact surface after the second connecting member rotates by a preset angle, during which the outer wing is in a folded state; and/or a third rotating contact surface is formed on the third connecting member and a fourth rotating contact surface is formed on the fourth connecting member, the third rotating contact surface abutting against the fourth rotating contact surface after the fourth connecting member is driven by the outer wing to rotate by a preset angle, during which the outer wing is in the folded state.

12. The wing according to claim 11, wherein a toggle block is arranged on the first rotating portion or the second rotating portion and a fifth touch switch is arranged on the first connecting member or the third connecting member; the toggle block touches the fifth touch switch when the first rotating contact surface abuts against the second rotating contact surface or the third rotating contact surface abuts against the fourth rotating contact surface; and the fifth touch switch is communicatively connected to the main control apparatus and the main control apparatus is further communicatively connected to the rotation output member and controls a working state of the rotation output member, the main control apparatus controlling, when the fifth touch switch is touched, the rotation output member to stop working.

13. The wing according to claim 12, wherein a sixth touch switch is arranged on the first connecting member and the sixth touch switch is arranged corresponding to the second connecting member, the second connecting member touching the sixth touch switch when the outer wing is in the unfolded state: or the sixth touch switch is arranged on the second connecting member and the sixth touch switch is arranged corresponding to the first connecting member, the first connecting member touching the sixth touch switch when the outer wing is in the unfolded state: or the sixth touch switch is arranged on the third connecting member and the sixth touch switch is arranged corresponding to the fourth connecting member, the fourth connecting member abutting against the sixth touch switch when the outer wing is in the unfolded state: or the sixth touch switch is arranged on the fourth connecting member and the sixth touch switch is arranged corresponding to the third connecting member, the third connecting member abutting against the sixth touch switch when the outer wing is in the unfolded state; and the main control apparatus is communicatively connected to the sixth touch switch, the main control apparatus controlling, when the sixth touch switch is triggered, the rotation output member to stop working.

14. An unmanned aerial vehicle, comprising a fuselage and a wing connected to the fuselage, wherein the wing comprises:
an intermediate wing assembly, configured to connect to a fuselage of the unmanned aerial vehicle;
an outer wing, arranged corresponding to the intermediate wing assembly and located on a side of the intermediate wing assembly away from the fuselage when the outer wing is in an unfolded state; and
a folding apparatus, comprising a driving unit and a coupling assembly, the driving unit being connected to the intermediate wing assembly; the coupling assembly facilitates rotational movement between the intermediate wing and the outer wing;
the driving unit is configured to transition the outer wing between the unfolded state and a folded state.

15. The unmanned aerial vehicle to claim 14, wherein the coupling assembly comprising a first rotating portion and a first fixed portion that are interconnected in a manner permitting rotation, the stationary member being connected to the outer wing, the first fixed portion being connected to the intermediate wing assembly and the first rotating portion being connected to the outer wing:
the first rotating portion being further connected to an output end of the driving unit, to enable the driving unit to drive the first rotating portion to rotate, the first rotating portion driving the outer wing to rotate relative to the intermediate wing assembly.

16. The unmanned aerial vehicle according to claim 14, wherein there are two outer wings, respectively arranged on two opposite sides of the intermediate wing assembly, the intermediate wing assembly being arranged across the fuselage.

17. The unmanned aerial vehicle according to claim 15, wherein the driving unit is a rotation output mechanism, an output end of the rotation output mechanism being connected to the first rotating portion, to drive the first rotating portion to rotate relative to the first fixed portion.

18. The unmanned aerial vehicle according to claim 17, wherein the rotation output mechanism comprises a rotation output member and a reducer, the rotation output member being connected to the intermediate wing assembly by a holder, an output end of the rotation output member being connected to an input end of the reducer and an output end of the reducer being connected to the first rotating portion.

19. The unmanned aerial vehicle according to claim 17, wherein the rotation output member is a steering gear or a motor, the rotation output mechanism further comprising a universal joint, an output end of the reducer being connected to the first rotating portion by the universal joint.

20. The unmanned aerial vehicle according to claim 15, wherein the folding apparatus further comprises a first connecting member and a second connecting member, the intermediate wing assembly being connected to the first fixed portion of the first rotating shaft by the first connecting member, the outer wing being connected to the first rotating portion by the second connecting member.
